(19) United States
(12) Patent Application Publication
(10) Pub. No.: US 2016/0007821 A1
(43) Pub. Date: Jan. 14, 2016

(54) HIGH DENSITY PAINT AND STAIN APPLICATION TOOL

(71) Applicant: Edward Goldstein, Minneapolis, MN (US)

(72) Inventor: Edward Goldstein, Minneapolis, MN (US)

(21) Appl. No.: 14/864,714

(22) Filed: Sep. 24, 2015

Related U.S. Application Data
(63) Continuation of application No. 14/245,757, filed on Apr. 4, 2014.
(60) Provisional application No. 61/809,210, filed on Apr. 5, 2013.

(51) Int. Cl. A47L 13/28; B05C 17/00

(52) U.S. Cl. CPC A47L 13/28; B05C 17/00

(57) ABSTRACT

A multi-purpose spray-like finish coating applicator tool comprising a rigid flat base member having a first surface and a second surface, a handle extending from the second surface of the rigid base member and a plurality of electrostatically flocked fibers each having a length of less than 0.150 inches located on the first surface of the base member with the flocked fibers forming a shed-resistant high-density layer of non-woven precision cut flocked fibers, the layer of non-woven precision cut flocked fibers distributing at least 1,000 square feet per gallon of coating materials to a non-floor coating surface to provide for a spray-like finish without the environmental hazard of atomizing solvent and chemical and fumes involved with traditional sprayer applicators.

### CROSS REFERENCE TO RELATED APPLICATIONS

This application is a continuation application of pending U.S. application Ser. No. 14/245,757, filed on Apr. 4, 2014; tiled HIGH DENSITY PAINT AND STAIN APPLICATOR TOOL, which claims priority to expired U.S. Provisional Application Ser. No. 61/809,210, filed on Apr. 5, 2013; tiled HIGH DENSITY PAINT AND STAIN APPLICATOR TOOL.

### FIELD OF THE INVENTION

This invention relates generally to surface coating tools and more specifically T-bar floor coaters, paint and stain pad applicators, paint/staining edgers, and trim pads having a layer of non-woven flocked fibers comprising a plurality of electrostatically flocked fibers each having a length of less than 0.150 inches for distributing floor coating materials in a streak-free and bubble-free manner along a floor surface.

### STATEMENT REGARDING FEDERALLY SPONSORED RESEARCH OR DEVELOPMENT

None

### REFERENCE TO A MICROFICHE APPENDIX

None

### BACKGROUND OF THE INVENTION

Applicator tools such as pad style applicators and gliding or spreading applicators such as pad style applicators and T-bar floor coaters, for applying a layer of finish on surfaces such as a concrete or wood flooring surfaces coating tools are well known in the art. The refills used for these T-bars floor coaters generally comprising of three different styles, namely genuine lambskin, woven pile fabric and flocked foam such as Nylfoam™, which is produced and sold by Padco Inc. of Minneapolis, Minn.

The genuine lambskin has a wool application surface made from actual lambskin with the wool pile still on the tanned skin backing. The pile height of the genuine lambskin based refills is approximately 0.75 inches and are generally used to apply high solvent finishes and water based finishes to surface where a really thick layer of finish is desired.

The woven fabric based refills generally are made from a fabric in which the fibers are woven and interlocked into a fabric backing to prevent shedding. The fibers for the woven fabric-based refills can be of many types of material. For example Nylon fibers with lengths of approximately 0.180 inches can be used to apply high solvent finishes and are preferred as they have a long life because they resist abrasion having the properties of resist shedding because the fibers are locked into the backing. Other fabrics may be used such as knit fabrics where the fibers are punched into the backing. Although the aforementioned knit fabrics are less expensive to manufacture and use, one of their disadvantages is that they tend to shed more.

The Nylfoam-based refills are the most widely used style of T-bar refills. The fibered surface is coated with Nylon fibers of approximately 0.180 inches in length. The foam backing of the Nylfoam-based refills are silkscreened or sprayed with a layer of adhesive and run under a hopper that distributes the fibers into the adhesive surface. The material is then oven cured to crosslink the adhesive.

Although genuine lambskin, woven pile fabric and Nylfoam-base refills work for their intended purpose, they often times leave streaks or too thick of a coating thereby resulting in delays cause by having to wait for the coating materials to dry. In addition, the conventional T-bar refill or replacement applicator currently has a maximum range of approximately 300-600 square feet per gallon coating material.

Since the largest share of the world's floor surfaces require a thinner layer of finish, such as but not limited to vinyl polishes and waxes, stone and tile sealers, interior wood stains, hardwood floor penetrating oils, hardwood and concrete ultraviolet cure finishes, and etc. . . . , use of the conventional T-bar refill or replacement applicators for these coating the aforementioned surfaces often times leads to unnecessary waste of the coating materials and while providing for a less desired resulting coat

### BRIEF SUMMARY OF THE INVENTION

The present invention comprises a non-woven elongated non-rolling floor applicator comprises an elongated cylindrical-shaped housing having a first end, a second end, a slot extending along a length of the housing from the first end to the second end of the housing and an interior surface supporting a plug portion of a T-bar flooring tool therein. The floor applicator includes a plurality of electrostatically flocked fibers each having a length of less than 0.150 inches located on an exterior surface of said elongated cylindrical-shaped housing with the plurality of electrostatically flocked fibers forming a shed-resistant high density layer of non-woven microfibers with the layer of non-woven microfibers having distributing at least 1,000 square feet per gallon of floor coating materials in a streak-free and bubble-free manner along a floor surface.

In one embodiment of the present invention the floor applicator includes a cushioning layer located on an exterior surface of the elongated cylindrical-shaped housing with the cushioning layer providing a reservoir for storing floor coating materials and the plurality of fibers are directly electrostatically flocked to the cushioning layer. In an alternative embodiment of the present invention the floor applicator the plurality of fibers are directly electrostatically flocked to an exterior surface of the elongated cylindrical-shaped housing.

### BRIEF DESCRIPTION OF THE DRAWINGS

FIG. 1 is a perspective view showing a refill or replacement non-woven elongated non-rolling floor applicator for use with a traditional T-bar floor tool;

FIG. 2 is a cross-sectional view of floor applicator of FIG. 1 taken along the lines 2-2;

FIG. 3 is a cross-sectional view of a refill or replacement floor applicator having fibers directly electrostatically flocked to the said elongated cylindrical-shaped housing;

FIG. 4 shows a cross-sectional view of a refill or replacement floor applicator similar to the floor applicator of FIG. 3 but with having tapering ends;

FIG. 5 shows a perspective view of a refill or replacement floor applicator having a cushioning layer having multiple regions with different electrostatically flocked fibers density;

FIG. 6 shows a cross-sectional a refill or replacement floor applicator similar to the floor applicator of FIG. 2 but having a closed end that is outwardly tapered;

FIG. 7 shows a cross-sectional a refill or replacement floor applicator similar to the floor applicator of FIG. 3 but having a closed end that is outwardly tapered;

FIG. 8 is a side view showing a paint and stain trimmer a plurality of fibers directly electrostatically flocked to a cushioning layer;

FIG. 9 is a perspective view showing a paint and stain edger having a plurality of directly electrostatically flocked to a cushioning layer;

FIG. 10 is a perspective view showing a paint and stain pad applicator having a plurality of fibers directly electrostatically flocked to a second side of rigid replaceable applicator pad; and

FIG. 11 is a side view showing a paint and stain pad applicator having a plurality of fibers directly electrostatically flocked to a second side of rigid replaceable applicator pad.

### DESCRIPTION OF THE PREFERRED EMBODIMENT

FIG. 1 is a perspective view showing an embodiment of the present invention comprising a refill or replacement non-woven elongated non-rolling floor applicator 10 for use with a traditional T-bar floor tool 11. T-bar floor tool 11 generally comprises an elongated plug portion 12 having a first end 12a and a second end 12b and a handle 13 connected to elongated plug portion 12 at proximate the mid-way point between the ends 12a and 12b of elongated plug portion 12.

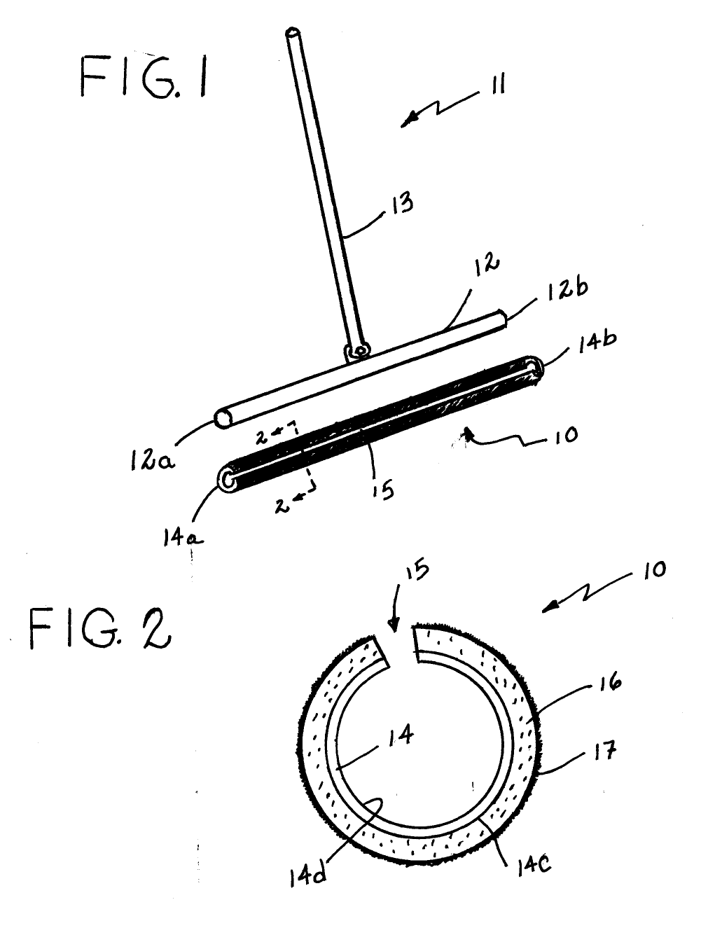

FIG. 2 is a cross-sectional view of floor applicator 10 taken along the lines 2-2. As shown in FIG. 2, floor applicator 10 comprise an elongated cylindrical-shaped housing 14 having a first end 14a, a second end 14b, a slot 15 extending along a length of housing 14 from first end 14a to second end 14b, an exterior surface 14c and an interior surface 14d supporting the plug portion 12 of T-bar flooring tool 11 therein.

Plug portion of a T-bar flooring tool may be removed from interior surface 14d of elongated cylindrical-shaped housing 14 for the replacement of the used floor applicator 10 with a fresh floor applicator 10 by laterally separating plug portion 12 of a T-bar flooring tool 11 from elongated cylindrical-shaped housing 14.

The embodiment of floor applicator 10 includes a cushioning layer 16 located on exterior surface 14c of elongated cylindrical-shaped housing 14. Cushioning layer 16 functions not only to absorb unevenness on the coating surfaces but also to provide for a reservoir for storing floor-coating materials.

Floor applicator 10 also includes a plurality of fibers each having a length of less than 0.150 inches and more preferably a length of less than 0.100 inches, and in certain applications a length of 0.050 inches or less directly electrostatically flocked to cushioning layer 16. For example, in certain coating applications the size of the individually electrostatically flocked fibers and comprises a size in the vicinity of 3 denier×0.030 inches.

The plurality of fibers that are directly electrostatically flocked to cushioning layer 16 forms a shed-resistant high-density layer of non-woven microfibers 17. A feature of the present invention is that due to the individual size of the electrostatically flocked fibers, the layer of non-woven microfibers 17 has the capability to distribute an ultra-thin, smooth coating in the range of at least 1,000-2,000 square feet per gallon of floor coating materials in a streak-free and bubble-free manner along a floor surface, which is much greater than the conventional T-bar refill or replacement applicator which currently has a maximum range of approximately 300-600 square feet per gallon. The layer of non-woven microfibers 17 also provides for greater ease in maintaining a precise layer of coating thus avoiding waste and using the minimum amount of finish for a perfect coat.

Providing for a surface coating range of at least 1,000-2,000 square feet per gallon or greater has many advantages compared to the limitations of the conventional T-bar refill or replacement applicator including avoiding waste of coating materials and providing for a more desired cleaner coat similar to that of a spray-like finish without the environmental hazard of atomizing solvent and chemical and fumes involved with traditional sprayer applicators. Since the largest share of the world's floor surfaces require a thinner layer of finish, such as but not limited to vinyl polishes and waxes, stone and tile sealers, interior wood stains, hardwood floor penetrating oils, hardwood and concrete ultraviolet cure finishes, and etc. . . . , providing for a surface coating range of at least 1,000-2,000 square feet per gallon or greater fulfills a great industry need.

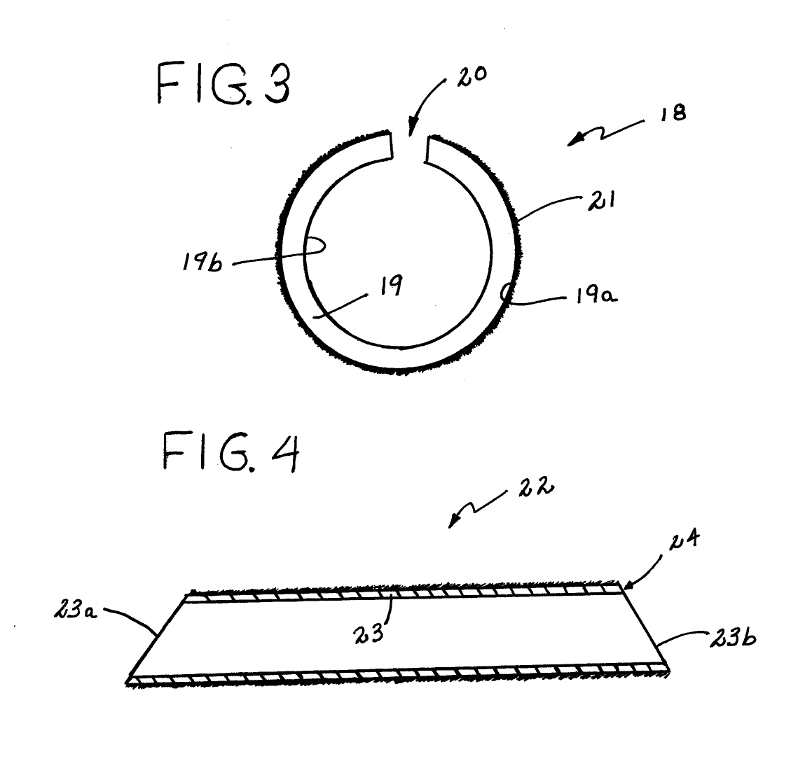

FIG. 3 is a cross-sectional view of an alternative embodiment of a refill or replacement non-woven elongated non-rolling floor applicator 18. Floor applicator 18 is similar to floor applicator 10 of FIGS. 1 and 2 in that floor applicator 18 comprise an elongated cylindrical-shaped housing 19 having a first end and a second end (not shown), a slot 20 extending along a length of housing 19 from the first end to the second end of housing 19, an exterior surface 19a and an interior surface 19b supporting a plug portion of a conventional T-bar flooring tool similar to T-bar flooring tool 11 shown in FIG. 1 therein.

Unlike the embodiment of floor applicator 10 of FIGS. 1 and 2, a feature of the present invention is that floor applicator 18 does not include a cushioning layer located on the exterior surface 19a of elongated cylindrical-shaped housing 19. Instead floor applicator 19 includes a plurality of fibers each having a length of less than 0.150 inches and more preferably a length of less than 0.100 inches, and in certain applications a length of 0.050 inches or less directly electrostatically flocked to the exterior surface 19a of elongated cylindrical-shaped housing 19. Similar to floor applicator 10, the plurality of fibers that are directly electrostatically flocked to the exterior surface 19a of elongated cylindrical-shaped housing 19 forms a shed-resistant high-density layer of non-woven microfibers 21 with the layer of non-woven microfibers 21 having the capability to distribute an ultra-thin, smooth coating in the range of at least 1,000-2,000 square feet per gallon or greater of floor coating materials in a streak-free and bubble-free manner along a floor surface.

FIG. 4 shows a cross-sectional end-to-end view of an alternative embodiment of a refill or replacement non-woven elongated non-rolling floor applicator 22 taken along a slot 24 of floor applicator 22. Floor applicator 22 includes all the corresponding features of floor applicator 18. However, unlike the embodiment of floor applicator 18, a feature of the present invention is that both ends 23a and 23b of an elongated cylindrical-shaped housing 23 of floor applicator 22 are outwardly and downwardly tapered from slot 24. That is, the end-to-end length of slot 24 is less than the end-to-end length of elongated cylindrical-shaped housing 23 most distal to slot 24.

The feature of the tapering ends of elongated cylindrical-shaped housing 23 allows for the application of coating materials to the surface of the flooring up to the baseboard trim or to the sidewall of a room while preventing the coating material from coming into contact with the baseboard trim or the sidewall of the room thereby resulting in no or minimal markings to the baseboard trim or to the side wall of the room.

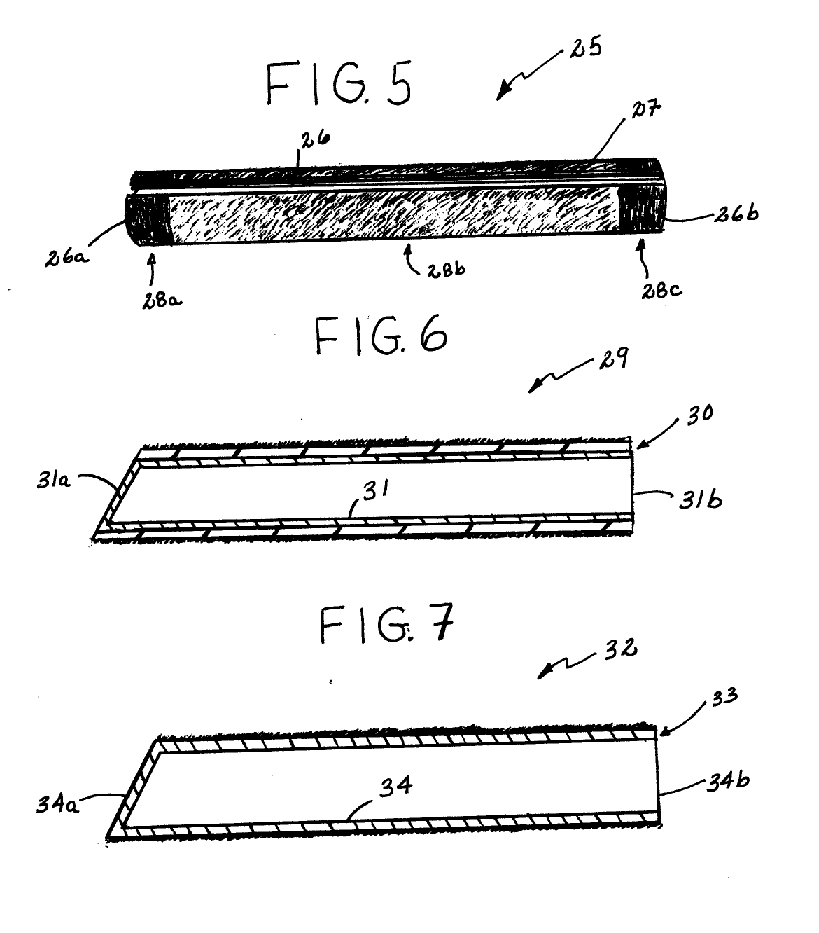

FIG. 5 shows a perspective view of an alternative embodiment of a refill or replacement non-woven elongated non-rolling floor applicator 25. Floor applicator 25 includes all the corresponding features of floor applicator 10 of FIGS. 1 and 2. However, unlike the embodiment of floor applicator 10, a feature of floor applicator 25 is that a layer of non-woven microfibers 28 of floor applicator 25 formed by a plurality of fibers that are directly electrostatically flocked to a cushioning layer 27 comprises a first region 28a, a second region 28b and a third region 28c with first region 28a and third region 28c of layer of non-woven microfibers 28 having a greater density of electrostatically flocked fibers than second region 28b of layer of non-woven microfibers 28. As shown in FIG. 5, first region 28a of layer of non-woven microfibers 28 located proximal a first end 26a and third region 28c of layer of non-woven microfibers 28 located proximal a second end 26b of an elongated cylindrical-shaped housing 26 and second region 28b of layer of non-woven microfibers 28 located between first region 28a and third region 28c of layer of non-woven microfibers 28.

The feature of the first region 28a and the third region 28c of layer of non-woven microfibers 28 having a greater density of electrostatically flocked fibers than second region 28b of layer of non-woven microfibers 28 allows for the application of coating materials to the surface of the flooring up to or closer to the baseboard trim or to the sidewall of a room while reducing the coating material from coming into contact with the baseboard trim or the sidewall of the room thereby resulting in minimal markings to the baseboard trim or to the side wall of the room.

FIG. 6 shows a cross-sectional end-to-end view of an alternative embodiment of a refill or replacement non-woven elongated non-rolling floor applicator 29 taken along a slot 30 of floor applicator 29. Floor applicator 29 includes all the corresponding features of floor applicator 10. However, unlike the embodiment of floor applicator 10, a feature of the present invention is that floor applicator 29 includes an elongated cylindrical-shaped housing 31 having a first closed end 31 a that is outwardly and downwardly tapered from slot 30 and a second end 3 lb comprising a non-tapered open end for receiving an end of the plug portion of a T-bar flooring tool there through.

FIG. 7 shows a cross-sectional end-to-end view of an alternative embodiment of a refill or replacement non-woven elongated non-rolling floor applicator 32 taken along a slot 34 of floor applicator 32. Floor applicator 32 includes all the corresponding features of floor applicator 18. However, unlike the embodiment of floor applicator 18 and similar to floor applicator 29, a feature of the present invention is that floor applicator 32 includes an elongated cylindrical-shaped housing 34 having a first closed end 34a that is outwardly and downwardly tapered from slot 33 and a second end 34b comprising a non-tapered open end for receiving an end of the plug portion of a T-bar flooring tool there through.

Referring to floor applicator 29 and floor applicator 32, although the feature of the tapering open ends of elongated cylindrical-shaped housing similar to the embodiment of floor applicator 22 of FIG. 4 is generally effective in allowing for the application of coating materials to the surface of the flooring up to the baseboard trim or to the sidewall of a room while preventing coating material from coming into contact with the baseboard trim or the sidewall of the room thereby resulting in no or minimal markings to the baseboard trim or to the side wall of the room, it has been discovered that in certain surface coating application the tapering region of the open ends of the elongated cylindrical-shaped housing sometimes functions as a reservoir that may temporarily supports coating materials therein, especially when the floor applicator has been recently loaded with coating materials. If the open tapering ends of elongated cylindrical-shaped housing happens to come into contact with the baseboard trim or the sidewall of the room while the tapering region of the open ends of the elongated cylindrical-shaped housing is supporting a volume of coating materials therein, the volume of coating materials supported by the tapering region of the open ends may lead to a splattering of coating material to the baseboard trim or to the side wall of the room, especially if the open tapering ends of the elongated cylindrical-shaped housing engages with the baseboard trim or the sidewall of the room with some force. In addition, the volume of coating materials supported by the tapering region of the open ends may lead to dripping when a turn is made at the end of the room.

The feature of the tapering closed ends 31a, 34a of elongated cylindrical-shaped housings 31, 34 is a solution to the above problem by eliminating the potential presence of a temporarily coating materials supporting reservoir formed by the tapering region of the open ends of the elongated cylindrical-shaped housing.

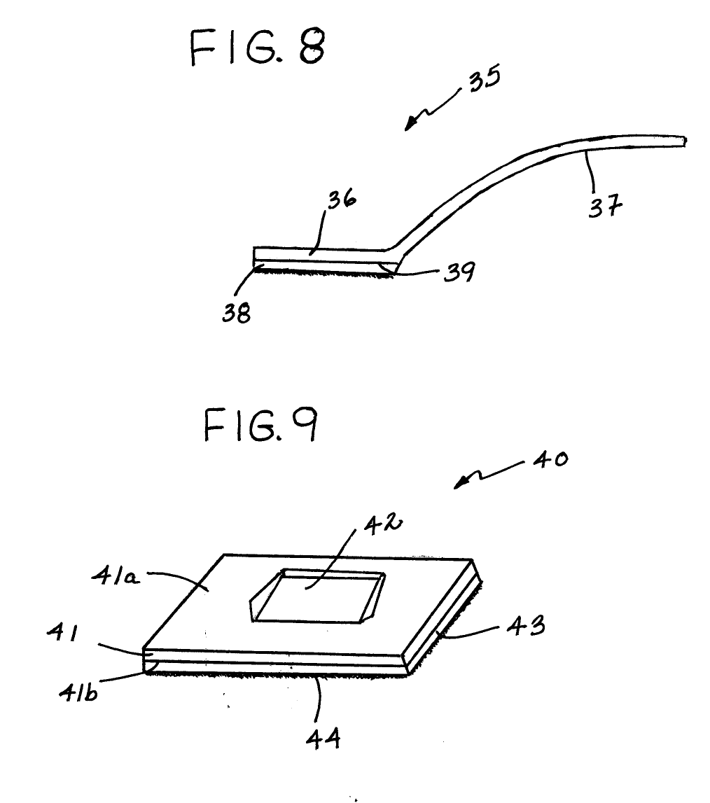

FIG. 8 is a side view showing a paint and stain trimmer 35 comprising a rigid base member 36 having a handle 37 extending therefrom. Rigid base member 36 includes a cushioning layer 38 located on an application surface 39 of rigid base member 36. Cushioning layer 38 functions not only to absorb unevenness on the coating surfaces but also to provide for a reservoir for storing floor-coating materials.

Paint and stain trimmer 35 also includes a plurality of fibers each having a length of less than 0.150 inches and more preferably a length of less than 0.100 inches, and in certain applications a length of 0.050 inches or less directly electrostatically flocked to cushioning layer 38 to form a shed-resistant high-density layer of non-woven microfibers 39.

FIG. 9 is a perspective view showing a paint and stain edger 40 comprising a rigid base member 41 having a first side 41a and a second side 41b. Rigid base member 41 includes a handle 42 attached to the first side 41a of rigid member 41 and a cushioning layer 43 located the second side 41b of rigid base member 41. Paint and stain edger 40 also includes a plurality of fibers each having a length of less than 0.150 inches and more preferably a length of less than 0.100 inches, and in certain applications a length of 0.050 inches or less directly electrostatically flocked to cushioning layer 43 to form a shed-resistant high-density layer of non-woven microfibers 44.

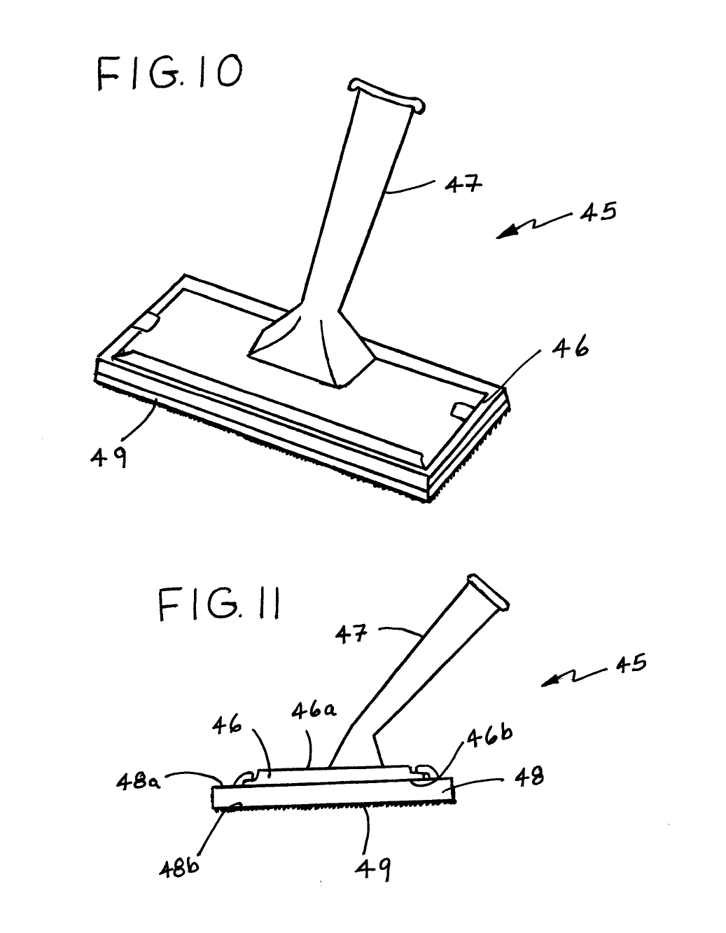

FIG. 10 is a perspective view and FIG. 11 is a side view showing a paint and stain pad applicator 45 comprising a rigid body 46 having a first side 46a and a second side 46b. Rigid body 46 includes a handle 47 extending from the first side 46a.

Paint and stain pad applicator 45 includes a rigid replaceable applicator pad 48 having a first side 48a for temporary attachment to the second side 46b of rigid body 46. Paint and stain pad applicator 45 also includes a plurality of fibers each having a length of less than 0.150 inches and more preferably a length of less than 0.100 inches, and in certain applications a length of 0.050 inches or less directly electrostatically flocked to a second side 48b of rigid replaceable applicator pad 48 to form a shed-resistant high-density layer of non-woven microfibers 49.

I claim:

1. A multi-purpose spray-like finish coating applicator tool comprising:
a rigid flat base member having a first surface and a second surface;
a handle extending from said second surface of said rigid base member; and
a plurality of electrostatically flocked fibers each having a length of less than 0.050 inches located on said first surface of said base member, said flocked fibers forming a shed-resistant high-density layer of non-woven precision cut flocked fibers, said layer of non-woven precision cut flocked fibers distributing at least 1,000 square feet per gallon of coating materials to a non-floor coating surface to provide for a spray-like finish without the environmental hazard of atomizing solvent and chemical and fumes involved with traditional sprayer applicators.

2. The multi-purpose spray-like finish coating applicator tool of claim 1 wherein said layer of non-woven precision cut flocked fibers distributing at least 2,000 square feet per gallon of a wax-free coating material to a coating surface to provide for a spray-like finish.

3. The multi-purpose spray-like finish coating applicator tool of claim 1 including a replaceable coating pad removably secured to said first surface of said rigid base member, said replaceable coating pad having a surface supporting said flocked fibers thereon.

4. The multi-purpose spray-like finish coating applicator tool of claim 3 wherein said flocked fibers are directly secured to said supporting surface of said replaceable coating pad.

5. The multi-purpose spray-like finish coating applicator tool of claim 4 wherein said replaceable coating pad includes a pair of curve-shaped ends located at opposing ends of said replaceable coating pad, said curve-shaped ends of said replaceable coating pad engaging a pair of corresponding arms extending at opposing ends of said base member to removably secure said replaceable coating pad to said base member.

6. The multi-purpose spray-like finish coating applicator tool of claim 2 wherein said plurality of flocked fibers are directly flocked to said first surface of said base member.

7. The multi-purpose spray-like finish coating applicator tool of claim 2 including a cushioning layer located on said first surface of said base member with said cushioning layer providing a reservoir for storing floor coating materials and wherein said plurality of electrostatically flocked fibers are directly flocked to said cushioning layer.

8. A multi-purpose spray-like finish coating applicator tool comprising:
a rigid flat base member having a first surface and a second surface;
a handle extending from said second surface of said rigid base member; and
a plurality of electrostatically flocked fibers each having a length of less than 0.150 inches located on said first surface of said base member, said flocked fibers forming a shed-resistant high-density layer of non-woven precision cut flocked fibers, said layer of non-woven precision cut flocked fibers distributing at least 1,000 square feet per gallon of coating materials to a non-floor coating surface to provide for a spray-like finish without the environmental hazard of atomizing solvent and chemical and fumes involved with traditional sprayer applicators.

9. The multi-purpose spray-like finish coating applicator tool of claim 8 wherein said electrostatically flocked fibers each have a length of 0.100 inches or less.

10. The multi-purpose spray-like finish coating applicator tool of claim 9 wherein said electrostatically flocked fibers each have a length of 0.050 inches or less.

11. The multi-purpose spray-like finish coating applicator tool of claim 10 wherein said layer of non-woven precision cut flocked fibers distributing at least 2,000 square feet per gallon of a wax-free coating material to a coating surface to provide for a spray-like finish.

12. The multi-purpose spray-like finish coating applicator tool of claim 8 including a rigid replaceable coating pad removably secured to said first surface of said rigid base member, said replaceable coating pad having a surface supporting said flocked fibers thereon.

13. The multi-purpose spray-like finish coating applicator tool of claim 13 wherein said flocked fibers are directly secured to said surface of said replaceable coating pad.

14. The multi-purpose spray-like finish coating applicator tool of claim 8 wherein said plurality of flocked fibers are directly flocked to said first surface of said base member.

15. The multi-purpose spray-like finish coating applicator tool of claim 8 including a cushioning layer located on said first surface of said base member with said cushioning layer providing a reservoir for storing floor coating materials and wherein said plurality of electrostatically flocked fibers are directly flocked to said cushioning layer.

16. A multi-purpose spray-like finish coating applicator tool comprising:
a rigid flat base member having a first surface and a second surface;
a handle extending from said second surface of said rigid base member; and
a plurality of electrostatically flocked fibers each having a length of less than 0.050 inches located on said first surface of said base member, said flocked fibers forming a shed-resistant high-density layer of non-woven precision cut flocked fibers, said layer of non-woven precision cut flocked fibers distributing at least 2,000 square feet per gallon of a wax-free coating material to a non-floor coating surface to provide for a spray-like finish without the environmental hazard of atomizing solvent and chemical and fumes involved with traditional sprayer applicators.

17. The multi-purpose spray-like finish coating applicator tool of claim 16 including a rigid replaceable coating pad removably secured to said first surface of said rigid base member, said replaceable coating pad having a surface supporting said flocked fibers thereon and said flocked fibers are directly secured to said supporting surface of said rigid replaceable coating pad.

18. The multi-purpose spray-like finish coating applicator tool of claim 17 wherein said replaceable coating pad includes a pair of curve-shaped ends located at opposing ends of said replaceable coating pad, said curve-shaped ends of said replaceable coating pad engaging a pair of corresponding arms extending at opposing ends of said base member to removably secure said replaceable coating pad to said base member.

19. The multi-purpose spray-like finish coating applicator tool of claim 16 including a cushioning layer located on said first surface of said base member with said cushioning layer providing a reservoir for storing floor coating materials and wherein said plurality of electrostatically flocked fibers are directly flocked to said cushioning layer.

20. The multi-purpose spray-like finish coating applicator tool of claim 16 wherein said plurality of flocked fibers are directly flocked to said first surface of said base member.
